(19) United States
(12) Patent Application Publication
(10) Pub. No.: US 2006/0231541 A1
(43) Pub. Date: Oct. 19, 2006

(54) Heater that attaches electronic component to and detaches the same from substrate

(75) Inventors: Rie Takada, Kawasaki (JP); Kenichiro Tsubone, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/191,986

(22) Filed: Jul. 29, 2005

(30) Foreign Application Priority Data
Apr. 14, 2005 (JP) 2005-116518

(51) Int. Cl. H05B 1/00

(52) U.S. Cl. 219/209

(57) ABSTRACT

A heater that attaches an electronic component having a ball grid array structure to and detaches the electronic component from a substrate on which the electronic component operates includes a body fixed onto the electronic component, and a heating element, provided on the body, which heats and melts soldering balls having the ball grid array structure when receiving power supply.

This application claims a right of foreign priority based on Japanese Patent Application No. 2005-116518, filed on Apr. 14, 2005, which is hereby incorporated by reference herein in its entirety as if fully set forth herein.

### BACKGROUND OF THE INVENTION

The present invention relates generally to an attachment of the electronic component to and a detachment of the same from a substrate, and more particularly to an apparatus that attaches a ball grid array (“BGA”) package to and detaches the same from a printed board.

Along with the recent spreading smaller and higher-performance electronic apparatuses, a demand for providing an electronic apparatus that realizes a high-density mounting has remarkably increased. The BGA package has been conventionally proposed to meet this demand. In general, the BGA package is mounted with an IC or LSI that serves as a CPU, and one type of a package board soldered to a printed board (also referred to as a “system board” or “motherboard”). The BGA package realizes a narrower pitch and more pins (i.e., high-density leads), and the high-density package provides a high-performance and small electronic apparatus.

The BGA package has plural soldering balls at a joint surface with the printed board. In mounting, the BGA package that has been arranged in place on the printed board is heated and soldered as the soldering balls are melted. This attachment is called a “reflow.” Characteristics of the BGA package mounted on the printed board are tested. The BGA package that does not exhibit predetermined performance is again heated to melt the solder and removed from the printed board, and a new BGA package is attached. This remounting (i.e., a procedure of a detachment and a subsequent attachment) is called a “rework.”

Referring now to FIG. 22, a description will be given of the conventional reflow and rework. Here, FIG. 22 is a schematic sectional view for explaining a heating mechanism 20 used for the conventional reflow and rework. A mounted substrate is a substrate (body) 10 mounted with BGA packages 12 and 14. For the mounted substrate used for recent communication apparatus, the substrate 10 has a multilayer structure and becomes expensive, because the mounted electronic components contain expensive special components. The BGA packages 12 and 14 have soldering balls 12a and 14a on joint surfaces with the substrate 10.

The conventional heating mechanism 20 arranges a head part 22 above a surface 11a of the substrate 10, and a stage part 24 that supports the substrate 10 under a rear surface 11b of the substrate 10. Each of the head part 22 and stage part 24 has a shield 25 and a ventilator 26a, and the stage part 24 further includes a full panel heater 27. The shield 25 is arranged above the front and rear surfaces of the substrate 10 around an object to be heated. The ventilator 26a sends the hot air from a heating source (not shown) to the object to be heated, above the front and back surfaces of the substrate 10. The full panel heater 27 is used to heat the BGA packages 12 and 14 together.

In reflow, the full panel heater 27 is used to attach the BGA packages 12 and 14 to the front surface 11a of the printed board 10, while the shields 25 and the ventilators 26a retreat from the substrate 10. When the reflow fails or when the BGA package 14 is defective as a result of the subsequent characteristic test, the BGA package 14 is replaced.

In rework, the shields 25 and the ventilators 26a are arranged above the front and back surfaces of the substrate 10 around the BGA package 14 that serves as an object to be heated. Then, the ventilators 26a send the hot air HA, while the shields 25 limit the heated areas to a neighborhood of the BGA packages 14 so that the hot air HA does not extend to the adjacent BGA packages 12.

Prior art include Japanese Patent Application, Publication No. 10-41606, 8-236984, 2004-186287 and 2000-151093.

There is an aperture between the shield 25 and the surface 11a of the substrate 10 so that the shield 25 does not collide with or damage the electronic component mounted on the substrate 10. Therefore, in the rework of the BGA package 14, the hot air HA leaking from the aperture heats the adjacent BGA packages 12, causing the internal electronic component to thermally deteriorate or get damaged. More specifically, the BGA packages 12 and 14 are heated during the reflow. In the reflow that removes the BGA package 14, the BGA packages 12 undergo the second heating, and the defective BGA package 14 is removed by an absorbing pickup and disposed. IN the following rework that attaches a new BGA package 14, the BGA packages 12 undergo the third heating, but it is the first heating for the new BGA package 14. Thus, when the BGA package 14 is exchanged, the BGA packages 12 are heated three times. The internal electronic components are likely to deteriorate or get damaged due to the heating plural times, and the warranty of their operations becomes difficult.

Conceivable solutions for this problem is to enlarge an interval between the BGA package 12 and 14 as shown in FIG. 23, and to protect the BGA package 12 using a heat insulator 15 and a heat absorber 16 as shown in FIG. 24. However, either method is contrary to the demand for a high-density mounting of the BGA package and the method of FIG. 24 additionally increases the cost and complicates mounting. The high-density mounting is necessary both the miniaturization of the electronic apparatus and maintenance of the performance, e.g., for reduced noises in the communications of two adjacent BGA packages. Moreover, if the shield 25 is closely adhered on the top surface 11a of the substrate 10, the hot air HA would not leak to the adjacent BGA packages 12 but the convection effect reduces and it takes a long time to heat up the BGA package 14, resulting in the low throughput.

FIG. 25 is a schematic sectional view of an example that replaces the BGA package 14 with a larger BGA package 14A. Small electronic components 13A and 13B are soldered and mounted on the substrate 10. In this case, the temperature of the large BGA package 14 is unlikely to rise and its soldering becomes difficult, even when the full heat panel 27 shown in FIG. 22 is used to heat up to the similar temperature in reflow. If the temperature of the full heat panel 27 is heated up to a higher temperature that can sufficiently solder the large BGA package 14A, other electronic components 12, 13A and 13B would thermally get damaged. It is thus conventionally difficult to mount the large electronic component 14A at high density.

### BRIEF SUMMARY OF THE INVENTION

Accordingly, it is an exemplary object of the present invention to provide a heater, an electronic apparatus and substrate having the heater, a substrate mounted with the electronic component, and an electronic apparatus that includes the mounted substrate, which sufficiently protect a surrounding electronic components from the heat during reflow and rework, and realize the high-density mounting.

A heater according to one aspect of the present invention that attaches an electronic component having a ball grid array structure to and detaches the electronic component from a substrate on which the electronic component operates includes a body fixed onto the electronic component, and a heating element, provided on the body, which heats and melts soldering balls having the ball grid array structure when receiving power supply. This heater is detachably attached to the BGA package, and does not heat the surrounding electronic component in rework unlike the hot air in the prior art, maintaining the operational guarantee of the electronic component. Of course, this heater is applicable to the reflow of the BGA package. The body may include accommodation parts that accommodate the soldering balls having the ball grid array structure. In this case, the heater is attached to the electronic component at the soldering ball side. Of course, the heater may be provided on the electronic component at a side opposite to the soldering ball. In this case, the accommodation part may be omitted.

The heating element may include plural, independently drivable heating element patterns. When one pattern cannot provide uniform heating and causes insufficient melting of the soldering ball, plural, independently drivable patterns can realize uniform heating. The plural, independently drivable heating element patterns may be multilayer patterns. Thereby, the heating element pattern can be arranged so that the entire soldering balls are uniformly heated when the density of a matrix of the soldering balls increases. The heater may further include a controller that controls heating of the plural, independently drivable heating element patterns. When one pattern cannot provide uniform heating and causes insufficient melting of the soldering ball, plural, independently drivable patterns can realize uniform heating. For example, the plural, independently driven heating element patterns may include a first pattern that extends zigzag through plural soldering balls, and a second pattern that enclose the first pattern. The second pattern may have a dense pattern at a corner of the plural soldering balls, because the heat is likely to escape particularly from the corners of plural soldering balls, causing insufficient heating.

The heater may further include an adiabatic member between the heating element and the electronic component. This configuration can reduce the thermal damages or deteriorations of the electronic component. Preferably, the heating element is arranged near a plane that passes through centers of the plural soldering balls. This arrangement can efficiently heat the plural soldering balls uniformly. The heater may further include a power supply part that can be electrically connected to and disconnected from the heating element, the power supply part electrifying the heating element. Thereby, the power supply part does not have to be placed on the substrate. This power supply part may be shared among plural heaters.

An electronic component according to another aspect of the present invention that has a ball grid array structure and can be mounted on a substrate includes a body that accommodates an electronic circuit element that can operate on the substrate, a soldering ball to be soldered on the substrate, and the above heater which melts the soldering ball. This electronic component exhibits the operations of the above heater, and facilitates handling because it is integrated with the heater. The heater may be located at the same side as or at an opposite side to the soldering ball with respect to the body. When it is provided at the opposite side, the accommodation part of the heater may be omitted.

A substrate according to another embodiment includes a substrate body that can mount an electronic component that has a ball grid array structure, a footprint provided on the substrate body and connected to the electronic component, and the above heater, provided around the footprint, which melts soldering ball having the ball grid array structure. This substrate exhibits the operations of the above heater, and facilitates handling because it is integrated with the heater. The heater may further include an adiabatic member between the heating element and the electronic component. Solder may be filled between the heating elements and on the footprint. Since a user does not have to fill the soldering paste on the footprint, the operability improves.

A method according to another aspect of the present invention for manufacturing an electronic component having a ball grid array structure includes the steps of forming a heating element that melts soldering balls having the ball grid array structure, and attaching the soldering balls to a body that accommodates an electronic circuit element. A method according to still another aspect of the present invention for manufacturing a substrate that can mount an electronic component having a ball grid array structure includes the steps of forming a footprint connected to an electronic component, on a body that can mount the electronic component, and forming a heating element around the footprints, which melts soldering balls having the ball grid array. These manufacturing methods produce the above electronic component and the substrate.

The heating element forming step may include the steps of forming a heating element pattern on an insulator, layering the insulators so as to hold the heating element pattern, and forming a hole (used to accommodate the soldering ball or expose the footprint) in a layered member formed by the layering step, wherein the method may further include the step of adhering to the body the insulator that has been layered. The adhering step utilizes, for example, one of a heatproof double-sided adhesive tape and a printed adhesive layer. Alternatively, the heating element forming step may include the step of forming a heating element pattern on a substrate using a fine processing technology.

A printed board having the above BGA package, and an electronic apparatus having the printed board constitute one aspect of the present invention.

Other objects and further features of the present invention will become readily apparent from the following description of the preferred embodiments with reference to accompanying drawings.

### BRIEF DESCRIPTION OF THE DRAWINGS

FIG. 1 is a schematic perspective view of an electronic apparatus according to one aspect of the present invention.

FIG. 2 is a schematic perspective view of a printed board mounted in the electronic apparatus shown in FIG. 1.

FIG. 3A is a schematic perspective view of a BGA package mounted on the printed board shown in FIG. 2, and FIG. 3B is a schematic sectional view along a broken line of FIG. 3A.

FIG. 4 is a schematic perspective view of a heater shown in FIG. 3B.

FIG. 5 is a schematic perspective view showing that a power supply is attached to the heater shown in FIG. 4 on the printed board shown in FIG. 3A.

FIG. 6A is a schematic plane view of a heating element pattern applicable to the heater shown in FIG. 4, and FIG. 6B is a schematic sectional view of FIG. 6A.

FIGS. 7A-7D show another embodiment of a heating element pattern having a multilayer structure applicable to the heater shown in FIG. 4, wherein FIG. 7A is a schematic plane view of the heating element pattern in a first layer, FIG. 7B is a schematic plane view of the heating element pattern in a second layer, FIG. 7C is a schematic plane view of the heating element pattern having the multilayer structure, and FIG. 7D is a schematic sectional view.

FIG. 8 is a schematic plane view of plural heating element patterns applicable to the heater shown in FIG. 4.

FIG. 9 is a schematic plane view of a variation of the heating element patterns shown in FIG. 8.

FIG. 10A is a schematic sectional view of a variation of the heater shown in FIG. 3A, and FIG. 10B is a schematic perspective view of the heater shown in FIG. 10A.

FIG. 11A is a schematic sectional view of a heater integrated BGA package, and FIG. 11B is a schematic plane view of FIG. 11A.

FIG. 12 is a flowchart for explaining a method for manufacturing the BGA package shown in FIG. 11A.

FIG. 13 is a flowchart for explaining another method for manufacturing the BGA package shown in FIG. 11A.

FIG. 14 is a flowchart for explaining still another method for manufacturing the BGA package shown in FIG. 11A.

FIG. 15 is a schematic sectional view as a variation of the BGA package shown in FIG. 11A.

FIG. 16A is a schematic sectional view of a heater integrated printed board, and FIG. 16B is a schematic plane view of FIG. 16A.

FIG. 17 is a flowchart for explaining a method for manufacturing the BGA package shown in FIG. 16A.

FIG. 18 is a flowchart for explaining another method for manufacturing the BGA package shown in FIG. 16A.

FIG. 19 is a flowchart for explaining still another method for manufacturing the BGA package shown in FIG. 16A.

FIG. 20 is a schematic sectional view as a variation of the BGA package shown in FIG. 16B.

FIG. 21 is a schematic sectional view as another variation of the BGA package shown in FIG. 16B.

FIG. 22 is a schematic sectional view for explaining the conventional rework technology.

FIG. 23 is another schematic sectional view for explaining the conventional rework technology.

FIG. 24 is still another schematic sectional view for explaining the conventional rework technology.

FIG. 25 is still another schematic sectional view for explaining the conventional rework technology.

### DETAILED DESCRIPTION OF THE PREFERRED EMBODIMENTS

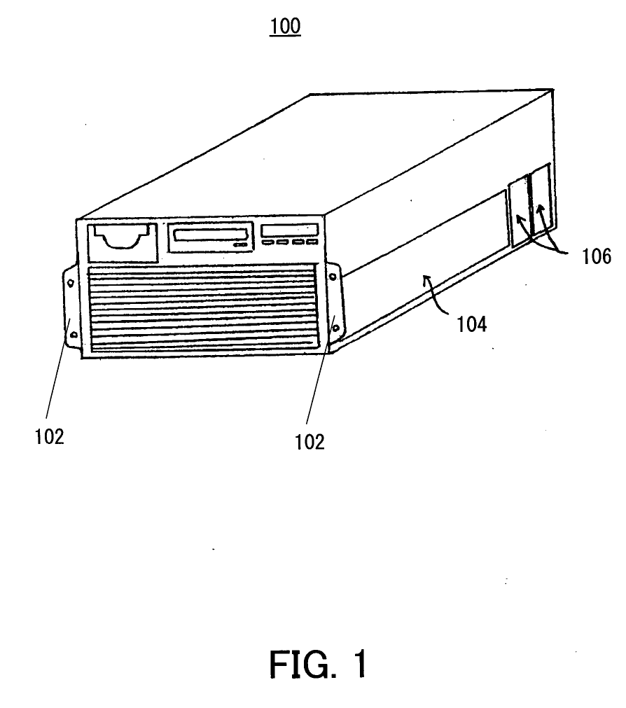

Referring now to the accompanying drawings, a description will be given of an electronic apparatus 100 according to one embodiment of the present invention. Here, FIG. 1 is a schematic perspective view of the electronic apparatus 100. As shown in FIG. 1, the electronic apparatus 100 is illustratively implemented as a rack mount type UNIX server. The electronic apparatus 100 is screwed onto a rack (not shown) by a pair of brackets 102, and includes a printed board 110 in a housing 104. Fan modules 106 are provided in the housing 104. The fan module 106 rotates a built-in cooling fan to generate the airflow, and compulsorily cools a heat sink in the housing 104.

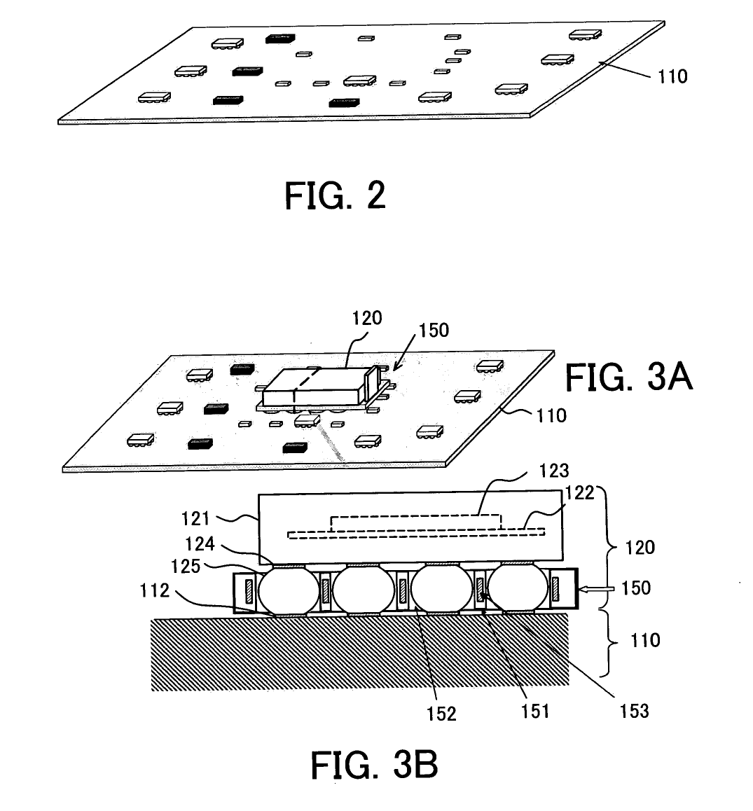

The printed board 110 includes a BGA package (or an electronic component) 120, a heater 150, plural block plates (not shown) used to insert a memory card, and a connector (not shown) with an external apparatus, such as a hard disc drive (“HDD”) and a local area network (“LAN”), etc. The printed board 110 includes plural footprints 112 on the substrate body 111, each of which serves as connecting part to a soldering ball 125 on the BGA package 120. Here, FIG. 2 is a perspective overview of the printed board 110 before the BGA package 120 and the heater 150 are mounted on the printed board 110. FIG. 3A is a perspective overview of the printed board 110 after the BGA package 120 and heater 150 are mounted on the printed board 110. FIG. 3B is a schematic sectional view of FIG. 3A taken along a broken line.

The BGA package 120 includes a body 121, and plural soldering balls or bumps 125. The body 121 is sealed, for example, by resin, accommodates a package board 122 and an electronic circuit element 123, such as an LSI, and includes plural pads 124 on its bottom surface. The package board 122 is made of resin or ceramics. The package board 122 is mounted with the electronic circuit element 123 on its top surface, and a capacitor and other circuit components (not shown) on its bottom surface. The electronic circuit element 123 may be an exoergic circuit element or a non-exoergic circuit element, and is soldered to the package board 122 via a terminal or bump (not shown). Underfill is filled between the electronic circuit element 110 and the package board 122 so as to guarantee connection reliability of the bump. Plural soldering balls 125 are attached to the pads 124 of the body 121, and the body 121 is fixed onto the printed board 110.

The soldering ball or bumps 125 are arranged in a lattice shape at a connection portion on the bottom surface of the body 121 for connection with the printed board 110. The soldering balls 125 may be arranged in a matrix shape or in a hollow square shape when a circuit element, such as a capacitor is located at the center. The heat-radiating heat sink may be arranged on the BGA package 120.

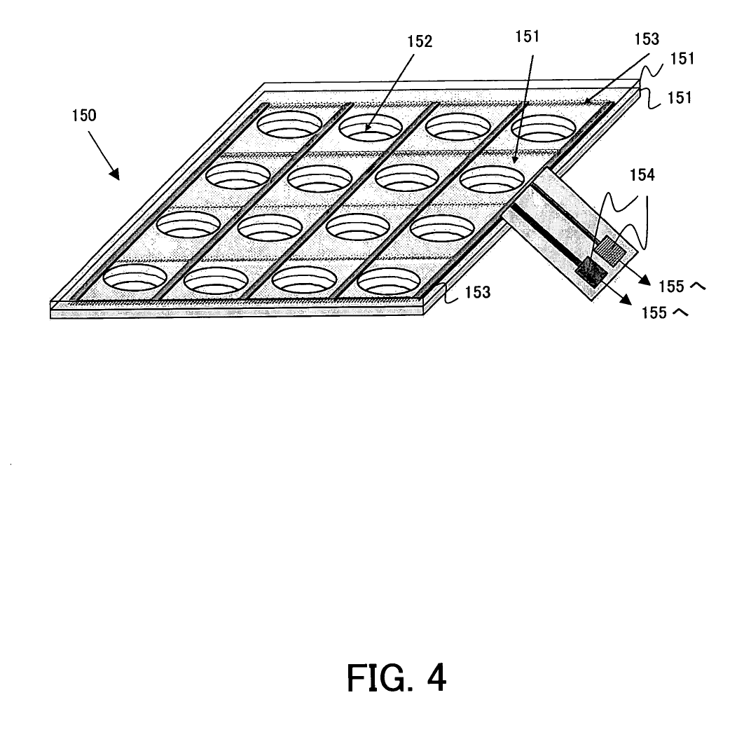

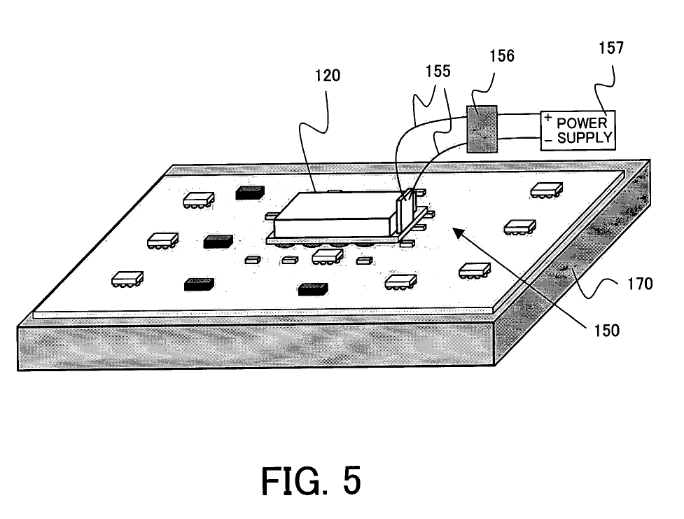

The heater 150 is used to attach the BGA package 120 to and detach the same from the printed board 110 (for reflow and rework). The heater 150 can be attached to and detached from the bottom surface of the BGA package 120. The heater 150 includes, as shown in FIGS. 4 and 5, a pair of insulating layers 151, plural accommodation holes 152, a heating element 153, a power-supplied part 154, a lead 155, a controller 156, and a power supply 157. Here, FIG. 4 is a perspective overview of the heater 150. FIG. 5 is a perspective overview showing that the lead 150, the controller 156, and the power supply 157 are attached to the heater 150.

The insulating layer 151 is made of an organic material, such as polyimide, and ceramics, etc., and has a layered structure that sandwiches the heating element 153. The accommodation hole 152 accommodates a soldering ball 125. The heating element 153 is a metal that melts the soldering ball 125 when receiving the power supply, and may use a nichrome wire, a stainless etched pattern, etc. The power-supplied part 154 is connected to the heating element 153, and soldered to the lead 155 so that it can be connected to and disconnected from the lead 155. The power supply 157 is connected to the lead 155 via the controller 156, and the controller 156 controls the electrification amount and time to the heating element 153. The controller 156 may be integrated with the power supply 157.

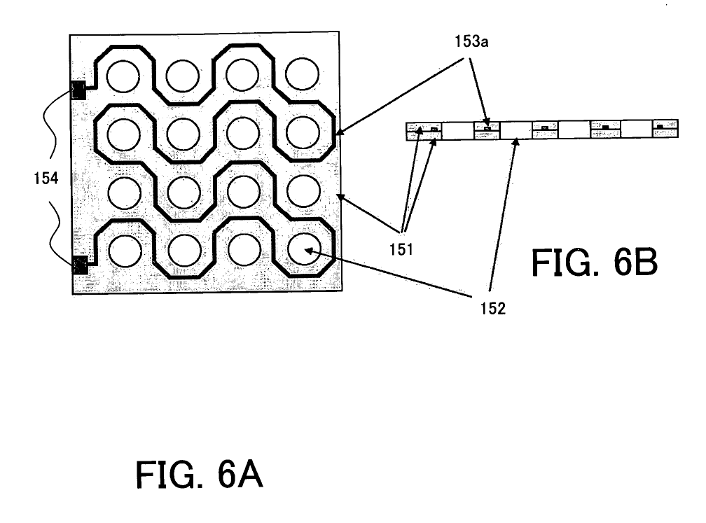

FIGS. 6A and 6B are schematic plane and sectional views of the heating element (pattern) 153a having a single layer structure. In FIG. 6A, it extends zigzag through the accommodation holes 152 that are arranged in a matrix. All the soldering balls 125 are uniformly heated by forming a uniform distribution of the heating element pattern around the accommodation holes 152.

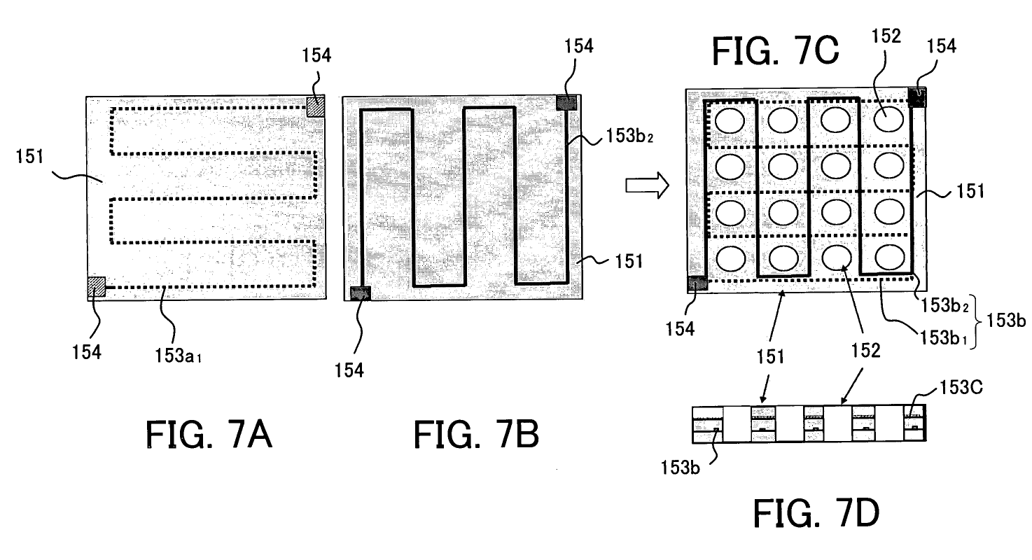

Alternatively, the heating element 153 may include plural, independently drivable heating element patterns. FIGS. 7A to 7D show the heating element pattern 153b having a two-layer structure. FIG. 7A is a schematic plane view of a heating element pattern 153b₁ in the first layer. FIG. 7B is a schematic plane view of a heating element pattern 153b₂ in the second layer. FIGS. 7A and 7B show a state before the accommodation holes 152 are created. The heating element patterns 153b₁ and 153b₂ have a relationship by rotating a convexoconcave pattern by 90°. FIG. 7C shows that the heating element patterns 153b₁ and 153b₂ overlap each other and are arranged around the accommodation holes 152. As shown in FIG. 7C, each soldering ball 125 is enclosed by the heating element patterns 153b₁ and 153b₂, and thus likely to be uniformly heated. FIG. 7D is a schematic sectional view showing a heating element pattern having a two-layer structure (or an insulating layer having a three-layer structure) 153b. Thus, the plural heating patterns eliminate a problem in that one heating pattern does not uniformly heat plural soldering balls 125 or result in insufficiently melted soldering ball 125. The heating element pattern having a multilayer structure can increase the density of a matrix of soldering balls 125 and heat all of the plural soldering balls 125 uniformly.

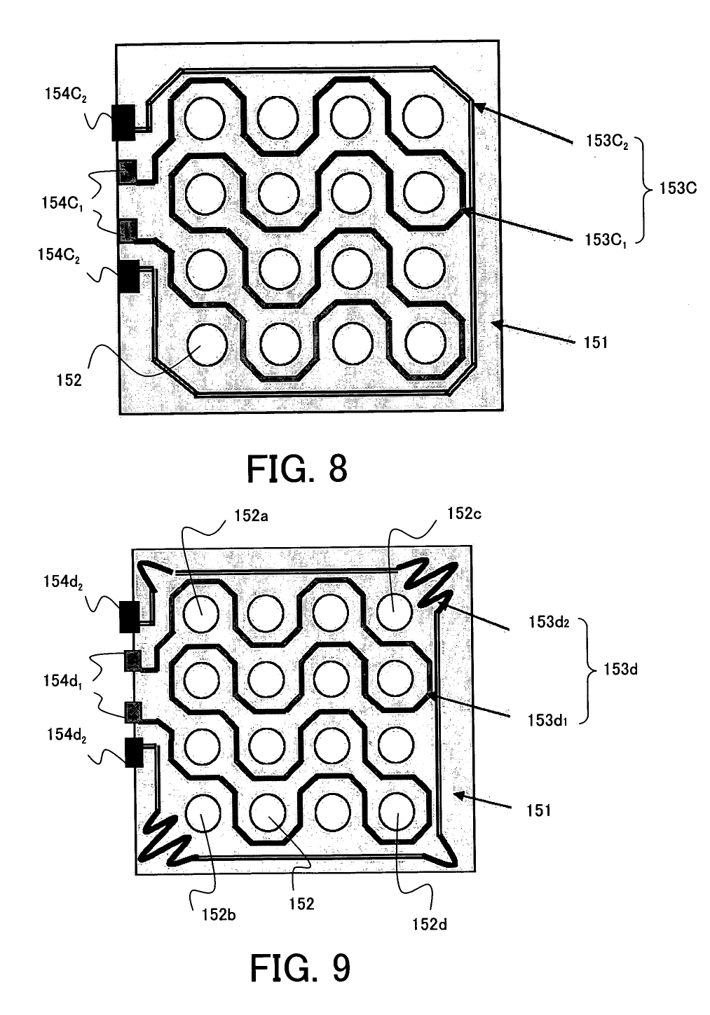

Of course, plural independently drivable heating patterns 153 may be arranged on the same plane. FIG. 8 is a schematic plane view of a heating element pattern 153c by arranging another heating element pattern 153c₂ around a heating element pattern 153c₁ similar to the heating element pattern 153a shown in FIG. 6. In general, the heat from the heating element pattern 153c₁ that heats up the outer-circumference accommodation holes 152 is likely to escape to the outside, and thus the heating element pattern 153c₂ covers the heating pattern 153c₁. In this case, the controller 156 may control independently and separately electrifications to a power-supplied part 154c₁ for the heating element pattern 153c₁ and a power-supplied part 154c₂ for the heating element pattern 153c₂. This configuration facilitates uniform heating of plural soldering balls 125.

FIG. 9 is a schematic plane view of a heat element pattern 153d by arranging another heating element pattern 153d₂ around a heating element pattern 153d₁ similar to the heating element pattern 153a shown in FIG. 6. While FIG. 9 arranges two heating element patterns on the same plane similar to FIG. 8, the heat element pattern 153d₂ is densely arranged at four corners. This is because the heat from the heating element pattern 153d₁ that heats the accommodation holes 152 at four corners is generally likely to escape to the outside. In addition, the heat is more likely to escape to the outside from the lower left and upper right accommodation holes 152b and 152c because they have a smaller number of sides covered by the heating element pattern 153d₁ than the upper left and lower right accommodation holes 152a and 152d. Therefore, the heating element pattern 153d₂ is densely arranged at the four corners in covering the heating element pattern 153c₁ and the corners that cover the lower left and upper right accommodation holes 152b and 152c are more densely arranged than the corners that cover the upper left and lower right accommodation holes 152a and 152d. This configuration facilitates uniform heating of plural soldering balls 125.

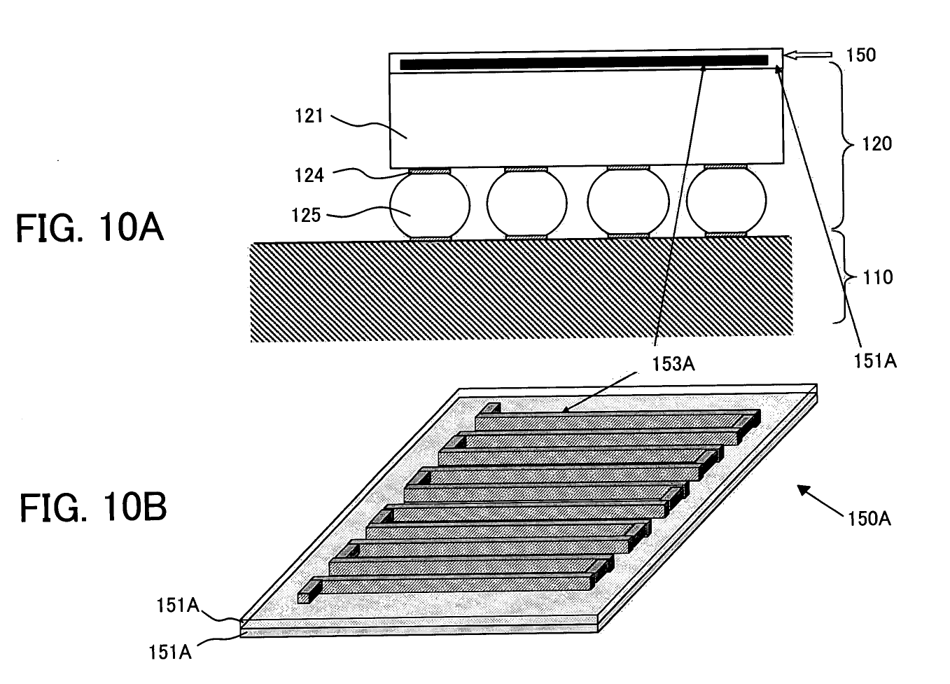

While the embodiment shown in FIG. 3B arranges the heater 150 at the same side as that of the soldering balls 125 with respect to the body 121, the heater 150 may be provided at the side opposite to the soldering balls 125 with respect to the body 121 when the body 121 is thin. FIG. 10A shows a schematic sectional view of a heater 150A of such an embodiment. FIG. 10B shows a schematic perspective view of the heater 150A. A heating element 153A melts the soldering balls 125. However, the heater 150A does not have an accommodation holes 152 different from the heating element 153 that is arranged around the accommodation holes 152 as shown in FIG. 4. Thus, the heating element 153A expands throughout the surface of the insulating layer 151A.

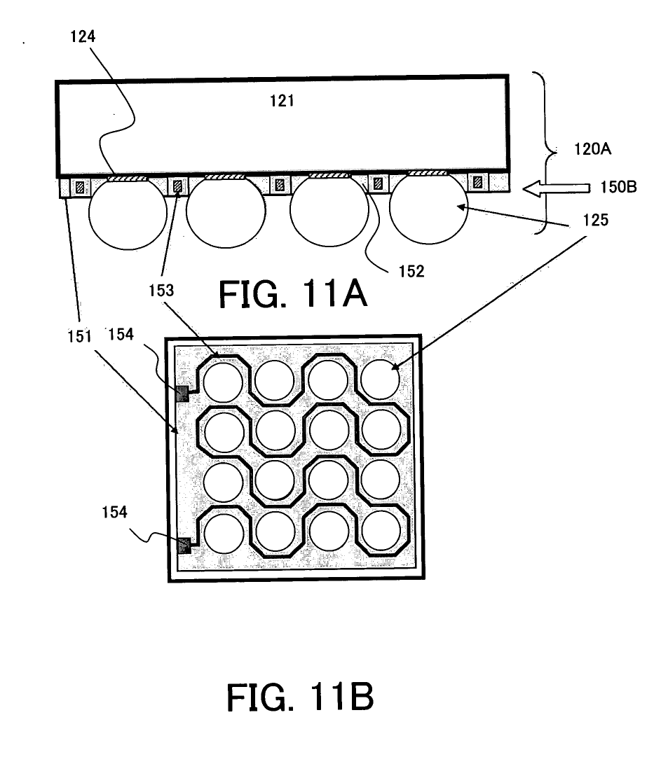

The heater 150 may be integrated with the BGA package 120 although they are separate members in FIG. 4. This embodiment will be described with reference to FIGS. 11A and 11B. Here, FIG. 11A is a schematic sectional view of a BGA package 120A with which the heater 150A is integrated, and FIG. 11B is its schematic bottom view. The BGA package 120A includes the body 121, the pad 124, and the soldering balls 125 similar to the BGA package 120, but different from the BGA package 120 in that it further includes a heater 150B that melts the soldering balls 125.

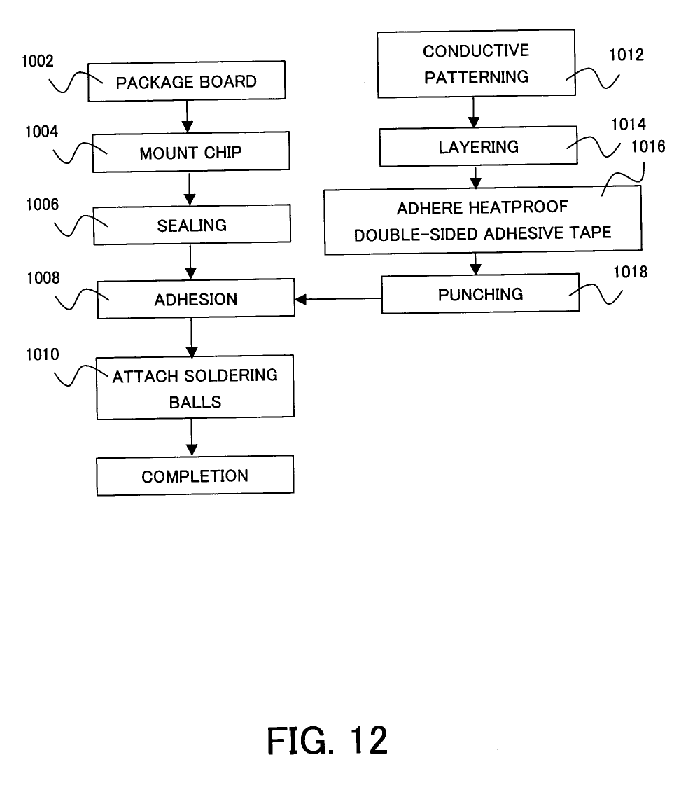

Referring now to FIGS. 12 to 14, a description will be given of several methods for manufacturing the BGA package 120A.

FIG. 12 is a flowchart showing a method for manufacturing the BGA package 120A by sticking the heater 150B with the BGA package 120 using a double-sided adhesive tape. First, a package board 122 is formed (step 1002). Next, an electronic circuit device 123 is mounted on the package board 122 (step 1004). Next, after other necessary circuits are mounted on the package board 122, the package board 122 is sealed (step 1006). On the other hand, steps 1012 to 1018 form the heater 150. That is, a conductor of the heat element pattern is patterned on the insulating layer 151 (step 1012). Next, an additional insulating layer 151 is layered (step 1014). For the heating element 153 having a multilayer structure, the steps 1012 to 1014 are repeated. Next, a heatproof double-sided adhesive tape is adhered to the layered member (step 1016). Next, the accommodation holes 152 are drilled by a punch (step 1018). Next, the heater 150 is adhered to the sealing member (step 1008). Finally, the soldering balls 125 are soldered to the pads 124 (step 1010).

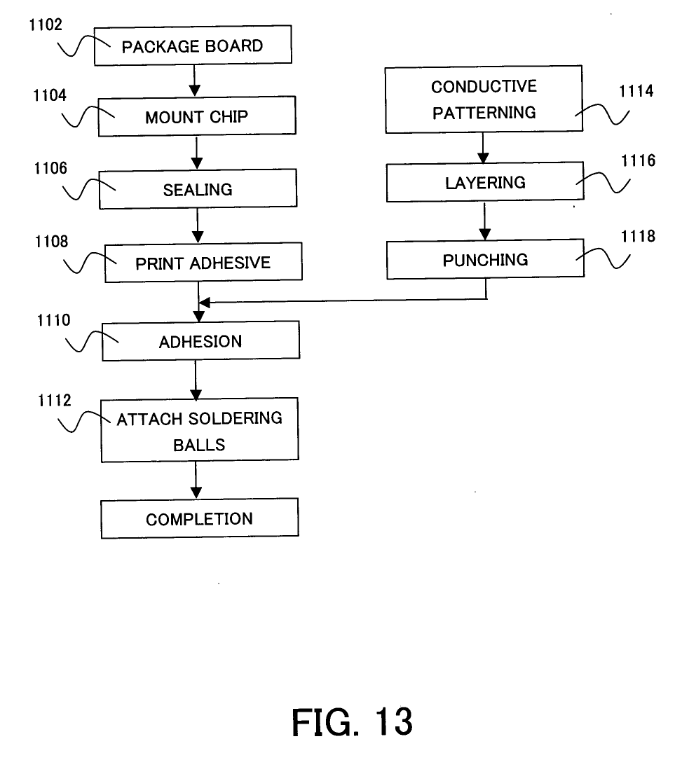

FIG. 13 is a flowchart showing a method for manufacturing the BGA package 120A by sticking the heater 150B with the BGA package 120 using adhesives. First, a package board 122 is formed (step 1102). Next, an electronic circuit device 123 is mounted on the package board 122 (step 1104). Next, after other necessary circuits are mounted on the package board 122, the package board 122 is sealed (step 1106). Next, an adhesive layer is printed on the sealed member (step 1108). On the other hand, steps 1114 to 1118 form the heater 150. That is, a conductor of the heat element pattern is patterned on the insulating layer 151 (step 1114). Next, an additional insulating layer 151 is layered (step 1116). For the heating element 153 having a multilayer structure, the steps 1114 and 1116 are repeated. Next, the accommodation holes 152 are punched (step 1118). Next, the heater 150 is adhered to the sealing member (step 1110). Finally, the soldering balls 125 are soldered to the pads 124 (step 1112).

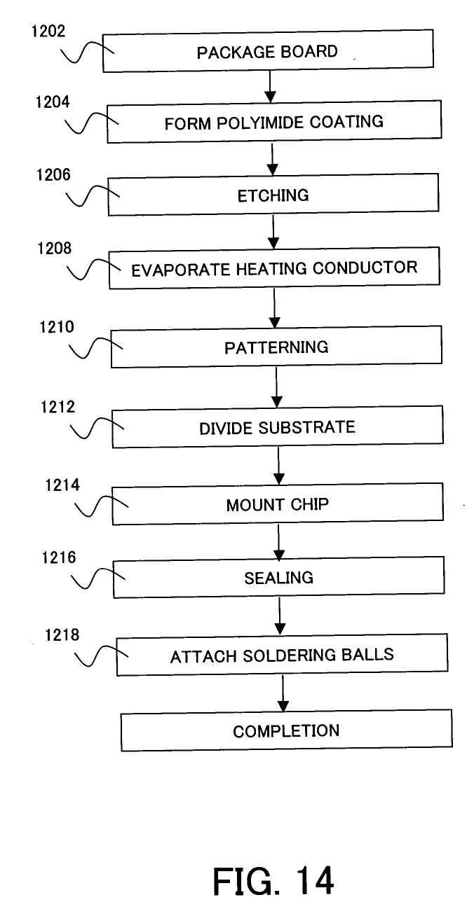

FIG. 14 is a flowchart showing a method for manufacturing the BGA package 120A by producing the heater 150B directly on the BGA package 120 using the fine processing technology. First, a package board 122 is formed (step 1202). Next, steps 1204 to 1210 form the heater 150. That is, a polyimide coating is formed (step 1204), and etching follows (step 1206). Next, a conductor of the heat element pattern is deposited (step 1208), and patterning follows (step 1210). Next, the substrate is divided (step 1212), and an electronic circuit device 123 is mounted on the package board 122 (step 1214). Next, after other necessary circuits are mounted on the package board 122, the package board 122 is sealed (step 1216). Finally, the soldering balls 125 are soldered to the pads 124 (step 1218).

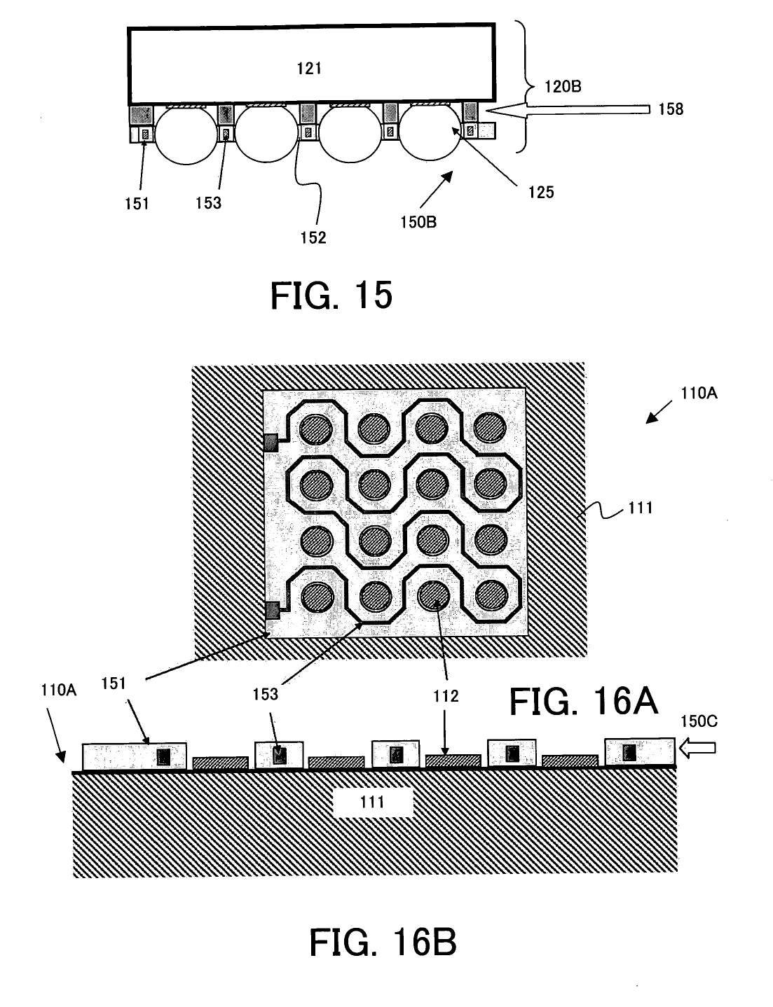

FIG. 15 is a schematic sectional view of a BGA package 120B as a variation of the BGA package 120A shown in FIG. 11. The BGA package 120B is different from the BGA package 120A in that the BGA package 120B includes a heater 150B that provides an adiabatic member 158 between each heating element 153 and the body 151. The adiabatic member 158 can reduce or prevent thermal damage or deterioration of the electronic circuit element 123 by the heat from the heating element 153. The heating elements 153 are arranged almost on a plane that connects plural soldering balls 125, and efficiently heat the soldering balls 125.

When the heater 150A is integrated with the BGA package, the order of the step 1008 and 1010 and the order of the steps 1110 and 1112 may be inversed.

The heater 150 is an independent member in FIG. 4, but may be integrated with the printed board 110. This embodiment will be described with reference to FIGS. 16A and 16B. Here, FIG. 16A is a schematic plane view of the printed board 110 with which the heater 150 is integrated, and FIG. 16B is its schematic sectional view. The printed board 10A includes the substrate body 111, footprints 112, and a heater 150C.

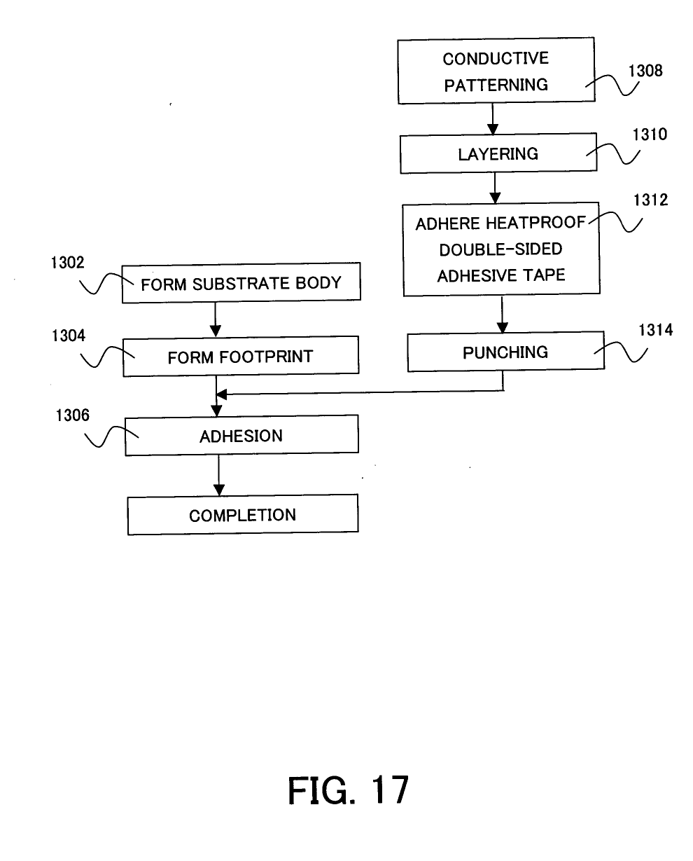

Referring now to FIGS. 17 to 19, a description will be given of several methods for manufacturing the printed board 110A.

FIG. 17 is a flowchart showing a method for manufacturing the printed board 110A by sticking the heater 150C with the printed board 110 using a double-sided adhesive tape. First, a substrate body 111 is made from resin or ceramics (step 1302). Next, the footprints 112 are formed on the substrate body 111 (step 1304). On the other hand, steps 1308 to 1314 form the heater 150C. That is, a conductor of the heat element pattern is patterned on the insulating layer 151 (step 1308). Next, an additional insulating layer 151 is layered (step 1310). For the heating element 153 having a multilayer structure, the steps 1308 and 1310 are repeated. Next, a heatproof double-sided adhesive tape is adhered to the layered member (step 1312). Next, areas corresponding to the accommodation holes 112 are punched (step 1314). Next, the heater 150C is adhered to the areas of the footprints 112 on the substrate body 111 (step 1306).

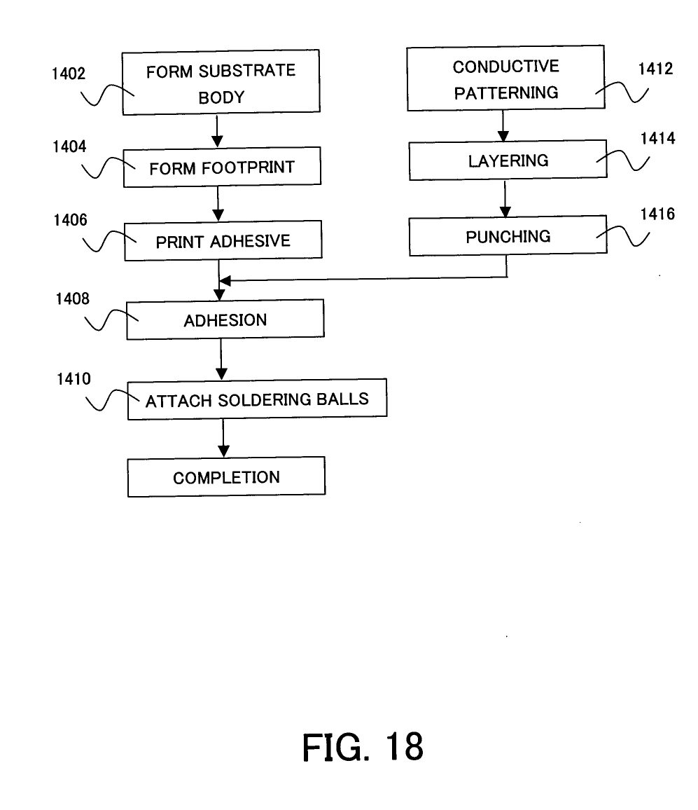

FIG. 18 is a flowchart showing a method for manufacturing the printed board 110A by sticking the heater 150C with the printed board 110 using adhesives. First, a substrate body 111 is made from resin or ceramics (step 1402). Next, an adhesive layer is printed on areas of the footprints 112 of the substrate body 111 (step 1406). On the other hand, steps 1412 to 1416 form the heater 150C. That is, a conductor of the heat element pattern is patterned on the insulating layer 151 (step 1412). Next, an additional insulating layer 151 is layered (step 1414). For the heating element 153 having a multilayer structure, the steps 1412 and 1414 are repeated. Next, the areas corresponding to the footprints 112 are punched (step 1416). Next, the heater 150 is adhered to the substrate body 111 (step 1408). Finally, the soldering balls 125 are soldered (step 1410).

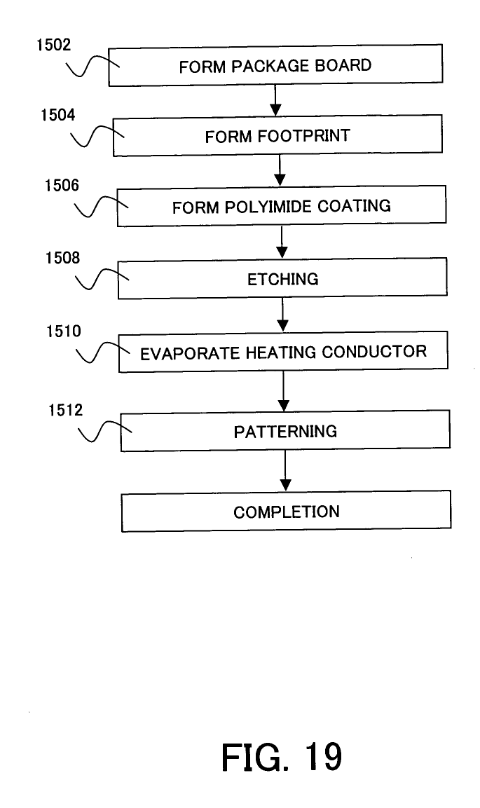

FIG. 19 is a flowchart showing a method of manufacturing the printed board 110A by producing the heater 150C directly on the substrate body 111 using the fine processing technology. First, the substrate body 111 is made of resin or ceramics (step 1502). Next, the footprints 112 are formed on the substrate body 111 (step 1504). Next, steps 1506 to 1512 form the heater 150C. That is, a polyimide coating is formed (step 1506), and etching follows (step 1508). Next, a conductor of the heating element pattern is deposited (step 1510), and patterning follows (step 1512).

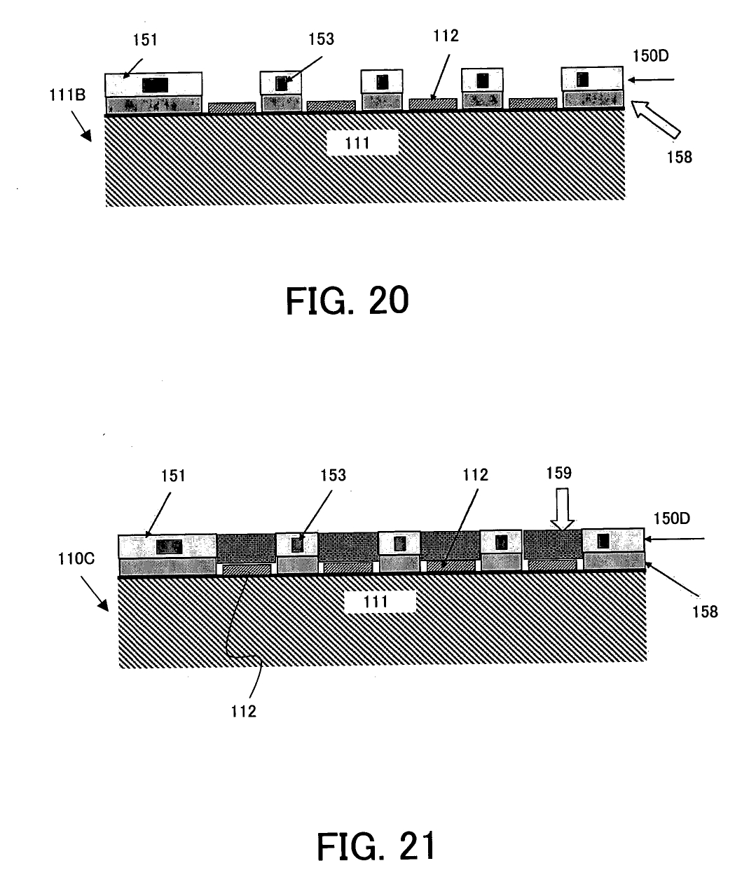

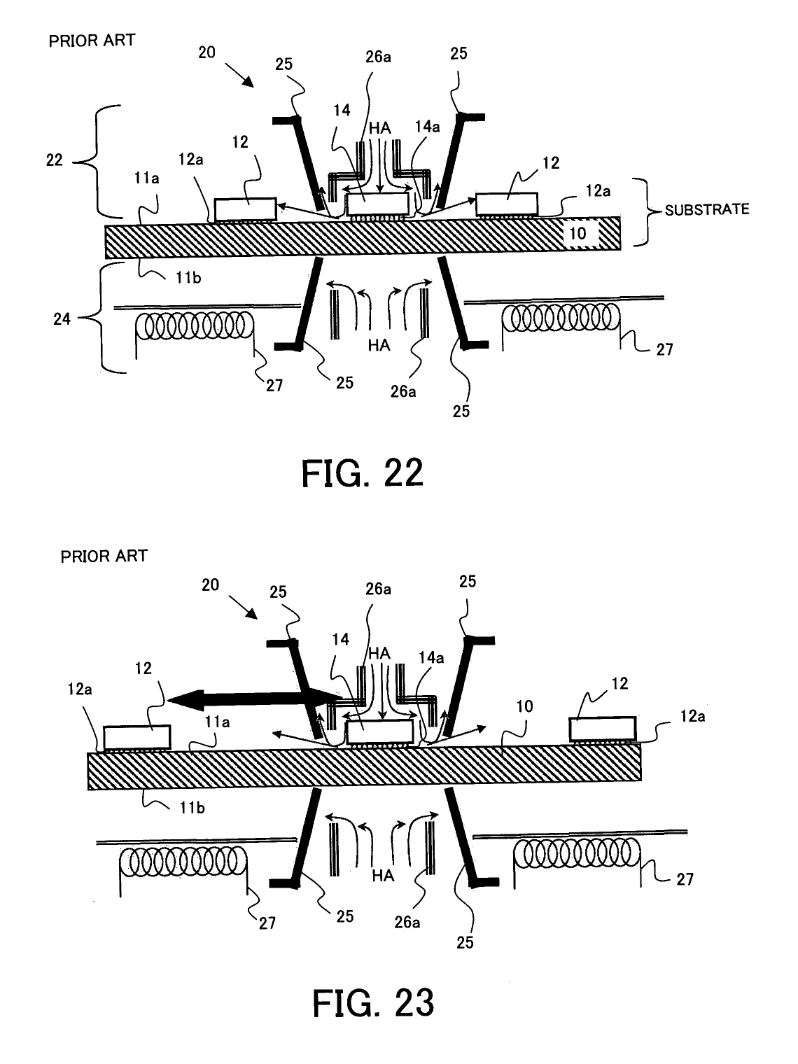

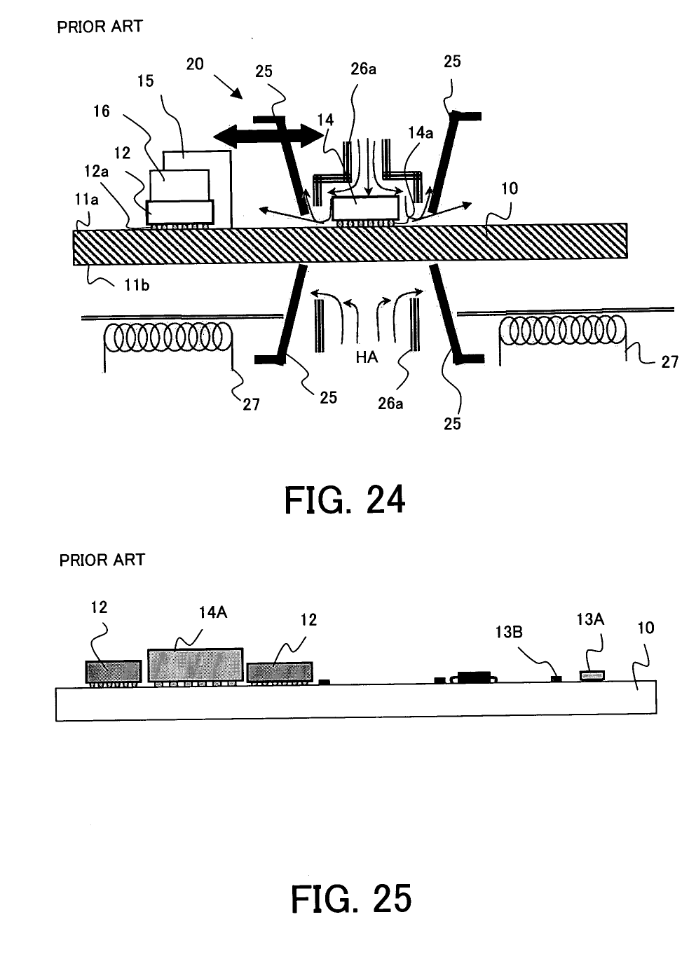

FIG. 20 is a schematic sectional view of a printed board 110B as a variation of the printed board 110A shown in FIG. 16B. The printed board 110B is different from the BGA package 120A in that the printed board 110B includes the heater 150D that provides an adiabatic member 158 between each heating element 153 and the substrate body 111. The adiabatic member 158 can reduce or prevent thermal damage or deterioration of the surrounding electronic circuit element due to the influence of the heat on the substrate body 111 from the heating element 153.

FIG. 21 is a schematic sectional view of the printed board 110C as a variation of the printed board 110B shown in FIG. 20. The printed board 110C is different from the BGA package 120A in that the printed board 110C fills or prints soldering paste 159 between the insulating layers and on the footprints 112. Thereby, in mounting the BGA package 120, the user does not have to fills the soldering paste 159 and improves the operability.

The adiabatic member 158 may be provided between each heating element 153 of the heater 150D and the BGA package 120 in FIGS. 20 and 21.

Referring now to FIGS. 2, 3 and 5, mounting of the BGA package 120 will be described. First, the BGA package 120 is arranged in place on the printed board 110 shown in FIG. 2 (FIG. 5). The lead 155, the controller 156 and power supply 157 are connected to the heater 150 before or after the BGA package 120 is positioned. Next, when the power is supplied to the heating element 153 from the power supply 157, the heating element 153 is heated and melts the soldering balls 125 and solders them to the footprint 125. In this case, a hot plate 170 or the like heats the entire bottom surface of the substrate 110, although the heating by the hot plate 170 is optional. Finally, the lead 155, the controller 156 and the power supply 157 are removed from the heater 150 (FIG. 3). In rework, the lead 155, the controller 156 and the power supply 157 are attached to the heater 150 so as to turn the state shown in FIG. 3 to the state shown in FIG. 5, and the electrification melts the soldering balls 153 and removes them from the footprint 112 (FIG. 2). In rework, a procedure to attach a new BGA package 120 is similar to that of the reflow. The previous heater 150 may be similarly used for the new BGA package 120.

FIG. 2 omits the footprints 112. The substrate 110 may have a structure shown in FIGS. 16, 20 or 21 and the usual BGA package 120 may be used.

According to this embodiment, the heater 150 locally heats the soldering balls 125 in the BGA package 120, but does not heat the surrounding electronic circuit element in reflow and rework of the BGA package 120. Therefore, the surrounding electronic circuit element is protected from the thermal damage or thermal deterioration. When the BGA package 120 is larger than the surrounding electronic component, the hot plate 170 and the heater 150 shown in FIG. 5 cooperate so as to melt the soldering balls 125 without the problem described in FIG. 25. Alternatively, in reflow, only the surrounding electronic component around the large BGA package 120 is attached, and the large BGA package 120 may be attached separately to the board 110 afterwards. As a result, the electronic components may be mounted at high density on the printed board 110, and the smaller and higher-performance electronic apparatus 100 can be configured.

Further, the present invention is not limited to these preferred embodiments, and various variations and modifications may be made without departing from the scope of the present invention.

Thus, the present invention can provide a heater, an electronic apparatus and substrate having the heater, a substrate mounted with the electronic component, and an electronic apparatus that includes the mounted substrate, which sufficiently protect a surrounding electronic components from the heat during reflow and rework, and realize the high-density mounting.

What is claimed is:

1. A heater that attaches an electronic component having a ball grid array structure to and detaches the electronic component from a substrate on which the electronic component operates, said heater comprising:
a body fixed onto the electronic component; and
a heating element, provided on said body, which heats and melts soldering balls having the ball grid array structure when receiving power supply.

2. A heater according to claim 1, wherein said body includes accommodation parts that accommodate the soldering balls having the ball grid array structure.

3. A heater according to claim 1, wherein said heating element includes plural, independently drivable heating element patterns.

4. A heater according to claim 3, wherein the plural, independently drivable heating element patterns are multilayer patterns.

5. A heater according to claim 3, further comprising a controller that controls heating of the plural, independently drivable heating element patterns.

6. A heater according to claim 3, wherein the plural, independently drivable heating element patterns include a first pattern that extends zigzag through plural soldering balls, and a second pattern that enclose the first pattern.

7. A heater according to claim 6, wherein the second pattern has a dense pattern at a corner of the plural soldering balls.

8. A heater according to claim 1, further comprising an adiabatic member between the heating element and the electronic component.

9. A heater according to claim 8, wherein said heating element is arranged near a plane that passes through centers of the plural soldering balls.

10. A heater according to claim 1, further comprising a power supply part that can be electrically connected to and disconnected from said heating element, the power supply part electrifying said heating element.

11. A substrate comprising:
a substrate body that can mount an electronic component that has a ball grid array structure;
a footprint provided on the substrate body and connected to the electronic component; and
a heater according to claim 1, provided around the footprint, which melts soldering ball having the ball grid array structure.

12. A substrate according to claim 11, wherein said heater further includes an adiabatic member between the heating element and the electronic component.

13. A substrate according to claim 11, wherein solder is filled between the heating elements and on the footprint.

14. A method for manufacturing a substrate that can mount an electronic component having a ball grid array structure, said method comprising the steps of:
forming a footprint connected to an electronic component, on a body that can mount the electronic component; and
forming a heating element around the footprints, which melts soldering balls having the ball grid array.

15. A method according to claim 14, wherein said heating element forming step includes the steps of:
forming a heating element pattern on an insulator;
layering the insulators so as to hold the heating element pattern; and
forming a hole in a layered member formed by said layering step,
wherein said method further comprises the step of adhering to the body the insulator that has been layered.

16. A method according to claim 15, wherein the adhering step utilizes one of a heatproof double-sided adhesive tape and a printed adhesive layer.
